(19) United States
(12) Patent Application Publication
(10) Pub. No.: US 2026/0195925 A1
(43) Pub. Date: Jul. 9, 2026

(54) IMPLICIT CODING OF PREDICTOR INDICES

(71) Applicant: GOOGLE LLC, Mountain View, CA (US)

(72) Inventor: Igor Vytyaz, Folsom, CA (US)

(21) Appl. No.: 19/424,399

(22) Filed: Dec. 18, 2025

Related U.S. Application Data
(60) Provisional application No. 63/742,379, filed on Jan. 6, 2025.

(51) Int. Cl. G06T 9/00

(52) U.S. Cl. CPC G06T 9/001

(57) ABSTRACT

Systems and methods for data compression are disclosed. A conventional codec that uses multiple prediction schemes encodes a predictor indicator for each data point, adding data overhead to the output stream. The disclosed technology reduces this overhead by conditionally omitting the predictor indicator. An encoder generates multiple predicted values for a data point using different prediction schemes. The encoder compares these values against a criterion, such as whether two or more values are equivalent. If the criterion is met, the predictor indicator is omitted from the output stream. A decoder, configured with the same deterministic logic, applies the same comparison to determine if a predictor indicator is present in the output stream and thereby identifies which predictor was used. Conditionally omitting the predictor indicator creates a more compact output stream and achieves an improved compression rate for the same reconstructed data.

### CROSS REFERENCE TO RELATED APPLICATION

This application claims the benefit of U.S. Provisional Application No.: 63/742,379, filed January 6, 2025, the disclosure of which is incorporated herein by reference in its entirety.

### BACKGROUND

Data compression is a fundamental enabling technology in modern computing. The explosive growth of digital information—spanning everything from high-definition video and audio to complex three-dimensional (3D) geometric constructs—has made efficient data handling a primary concern. Compression techniques are widely employed to reduce the size of these digital assets, which in turn lowers storage costs and decreases the bandwidth required for transmission over networks. Consequently, nearly every form of digital media and communication relies on some form of data compression to function effectively.

### SUMMARY

Disclosed herein are systems and methods for data compression. In some implementations, a method includes receiving input data that includes a data point. The method further includes generating a plurality of predicted values for the data point, such as a first value from a first candidate prediction scheme and a second value from a second candidate prediction scheme. Both prediction schemes may generate their respective values based at least in part on a current state, which can be determined from previously processed information. An output stream is then generated that includes a residual value, where the residual value is based at least in part on a difference between the data point and one of the first value or the second value.

In some implementations, the method further includes selecting one of the first or second values based at least in part on a comparison between the values against a threshold value, wherein the residual value is based on this selection. When the comparison indicates the values differ by more than the threshold, a predictor indicator may be included in the output stream to identify the selected prediction scheme. Conversely, when the comparison indicates the values are within the threshold, the predictor indicator may be omitted. A corresponding decoding method reconstructs the data point from the encoded stream by applying the same comparison logic to infer which predicted value to use, even without an explicit predictor indicator.

In some implementations, a system is provided that includes at least one processor and at least one memory storing instructions. When executed by the processor, the instructions cause the system to perform the encoding and decoding operations. The system may generate the output stream by omitting the predictor indicator under certain conditions and subsequently reconstruct the data point from that same output stream by inferring which predictor was used based on the shared logic.

It is appreciated that the described systems and methods can include any combination of the aspects and features described herein and are not limited to the specific combinations set forth in the disclosure. Moreover, the details of one or more implementations are set forth in the accompanying drawings and the description below. Other features and advantages will be apparent from the description and drawings, and from the claims.

### BRIEF DESCRIPTION OF THE DRAWINGS

The following detailed description that sets forth aspects of the subject matter, along with the accompanying drawings of which:

FIG. 1 is a conceptual diagram illustrating a technical context for implicit predictor coding using a three-dimensional mesh according to one implementation of the present disclosure;

FIG. 2A is a block diagram illustrating an encoder/decoder system for performing implicit predictor coding according to one implementation of the present disclosure;

FIG. 2B is a block diagram illustrating an encoder system in more detail according to one implementation of the present disclosure;

FIG. 2C is a block diagram illustrating a decoder system in more detail according to one implementation of the present disclosure;

FIG. 3 is a flowchart illustrating a process for encoding an output stream using implicit predictor coding according to one implementation of the present disclosure;

FIG. 4 is a flowchart illustrating a process for decoding an encoded stream that uses implicit predictor coding according to one implementation of the present disclosure; and

FIG. 5 is a block diagram illustrating an example computing system that may be employed to provide implementation of the present disclosure.

Like reference numbers may refer to like elements.

### DETAILED DESCRIPTION

In data compression, particularly for media like video, images, and 3D geometric meshes, codecs employ predictive coding to achieve high efficiency. These systems rely on prediction schemes—specialized algorithms that analyze previously processed data to anticipate the value of a subsequent data point. To maximize accuracy across diverse data types, a codec often utilizes a plurality of different prediction schemes and selects the one that provides the most accurate prediction for each data point. The choice of which prediction scheme was used is then encoded into the output stream as a "predictor index" so that a decoder can apply the same scheme to reconstruct the original data.

A conventional approach presents a core technical problem rooted in the inefficient use of computer resources and processing limitations. For every data point predictively encoded, the computer system is forced to allocate memory and write an explicit predictor index into the output stream, regardless of whether that index provides useful information. The inclusion of such redundant data unnecessarily consumes storage capacity on computer-readable media and unnecessarily increases network bandwidth consumption during transmission. The resulting computational inefficiency establishes a flawed operational trade-off within the computer system: improving predictive accuracy by using more predictors directly degrades the system’s performance by increasing the data overhead, a limitation in the functioning of conventional compression systems.

The disclosed methods provide a specific technical solution that improves the functioning of the computer system itself by overcoming this inherent inefficiency. The solution is not merely the abstract idea of saving space, but an unconventional data processing technique that alters the structure of the data generated by the computer. The ordered combination of steps is unconventional because it deviates from the routine and conventional practice of always encoding a predictor index. Instead, the disclosed process implements a specific, non-routine logic wherein the computer system: (1) for a given data point, executes multiple prediction schemes to generate a set of predicted values; (2) computationally compares these values against a specific criterion; and (3) conditionally alters the structure of the output stream by omitting the predictor index when the criterion is met. The process of conditionally altering the output stream represents a direct improvement to the computer's functionality because it enables the computer to generate a more efficient data structure, reducing the memory access operations and network bandwidth required to store and transmit the same information.

A primary technical advantage of this process is the creation of a more compact, efficient output stream that allows for lossless reconstruction of the original data. Because both the encoder and decoder are configured to apply the same deterministic logic, the decoder can correctly infer which prediction scheme was used even when the predictor index is absent. The technique of leveraging shared logic to implicitly communicate information represents a specific alteration to the computer's functionality by transforming the operational paradigm of the codec from one that requires explicit instruction for every data point. The following sections provide a detailed technical explanation of this process with reference to the accompanying figures.

As used herein, a “data point” may refer to a discrete unit of data within a larger data set, such as a pixel in an image, a target vertex of a three-dimensional mesh, or a sample in an audio stream. A vertex may comprise a “vertex attribute.” A vertex attribute is a data component associated with a vertex that can identify a specific property of the vertex beyond its topological relationship to other vertices in a mesh. For example, a vertex attribute may be selected from a group consisting of a vertex position, a vertex normal, and a texture coordinate. A “prediction scheme” may refer to an algorithm used to predict the value of a data point based on previously processed data points. A “parallelogram-based prediction scheme” is one such scheme that predicts a vertex position by completing a parallelogram formed by vertices in a prediction neighborhood. A “residual value” may refer to the difference between the actual value of a data point and a value predicted by a prediction scheme. A “predictor indicator” may refer to information included in a data stream that identifies which prediction scheme was used to generate a corresponding residual value.

A “current state” may refer to information derived from previously processed data points that is used as an input by a prediction scheme to predict a value for a subsequent data point. The current state establishes the predictive context for the data point being processed. The current state can be, for example, the set of data available to a prediction algorithm at a specific point in time, a data structure that stores reconstructed values from previously processed data points, or the cumulative information that an encoder or decoder has processed. In the context of a three-dimensional mesh, an example of a current state for a target vertex is its prediction neighborhood.

A “prediction neighborhood” is a type of current state for a target vertex of a three-dimensional mesh, and it refers to a set of previously processed vertices that are used to predict a value for the target vertex. Vertices in the prediction neighborhood are typically “topologically connected” to the target vertex. Two vertices are “topologically connected” if they share a common mesh element, such as a common edge or a common face. A “threshold value” may refer to a predefined value used as a benchmark in a comparison between two or more predicted values. A “predetermined rule” may refer to a deterministic rule shared by an encoder and a decoder for selecting a prediction scheme when multiple schemes produce equivalent values, such as selecting the scheme with the lowest index. A “hierarchical set of rules” may refer to a sequence of conditional comparisons, where a subsequent comparison is performed only if a preceding comparison fails to meet a specified criterion.

A “proxy version” may refer to a representation of a source media file having a different data representation than the source media file, such as one with a reduced data size or lower resolution that allows for more efficient handling or real-time editing. A “quality metric” may refer to a quantitative score or data structure generated from a comparison between a reconstructed data point and its original state. The quality metric quantifies a fidelity or an error introduced by an encoding and decoding process. Examples of a quality metric include a peak signal-to-noise ratio (PSNR) or a structural similarity index (SSIM).

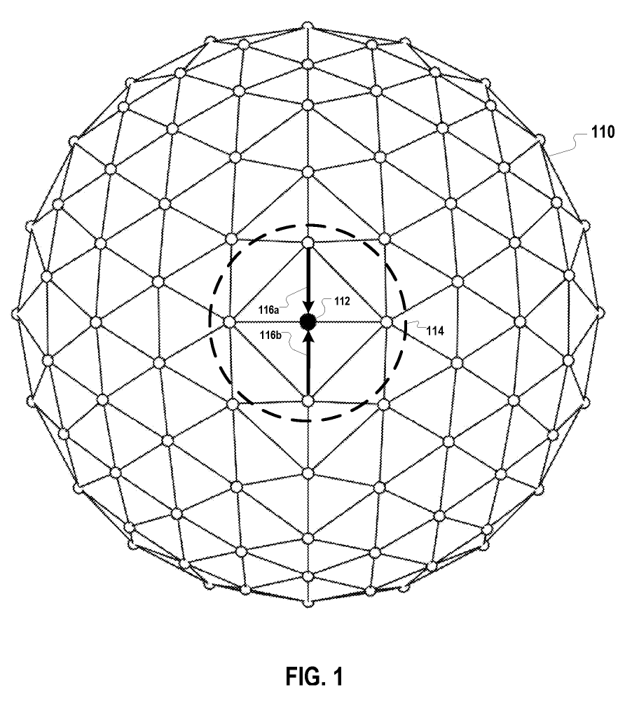

FIG. 1 is a conceptual diagram illustrating a technical context for implicit predictor coding. The figure shows a portion of a three-dimensional (3D) mesh 110, which serves as a concrete example of data being compressed. Within the mesh 110, several previously encoded vertices form a prediction neighborhood 114 that is used to predict the value of a subsequent target vertex 112. Arrows 116a and 116b, labeled as distinct candidate prediction schemes, point to the target vertex 112, representing the process of generating multiple predicted values where the prediction schemes use the vertices in the prediction neighborhood 114 as input.

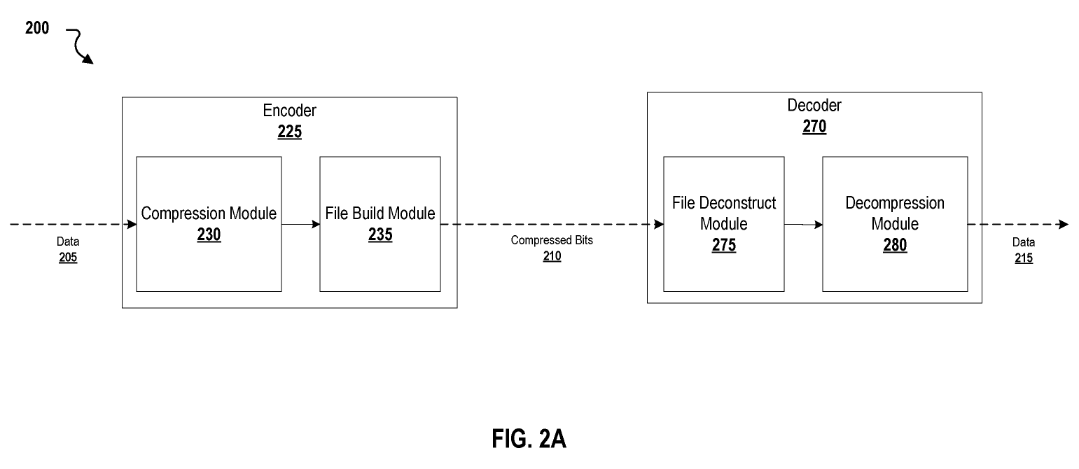

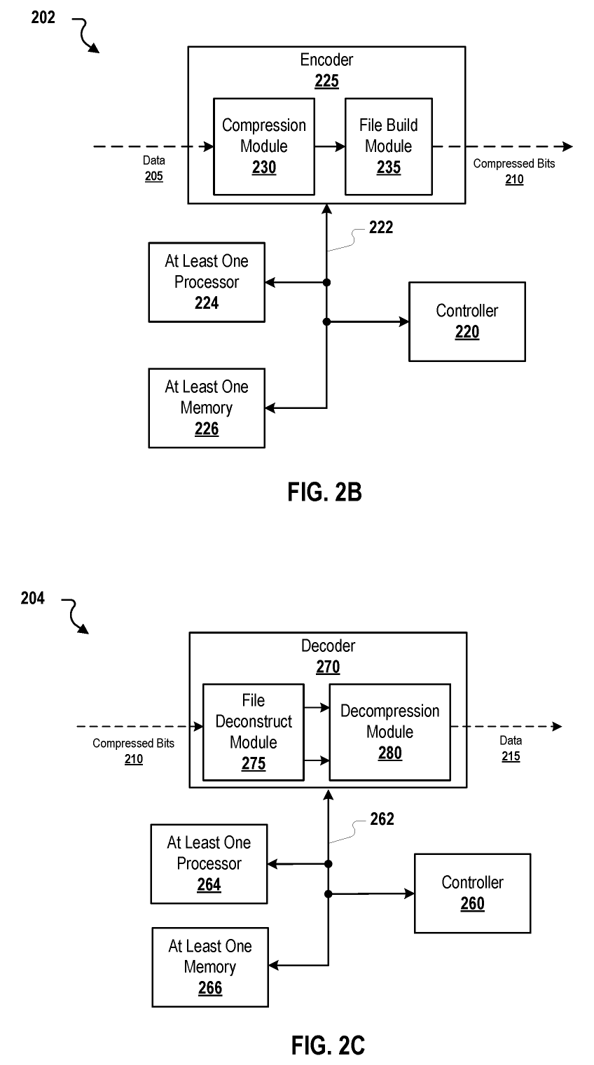

FIG. 2A is a block diagram illustrating an encoder/decoder system 200 for performing implicit predictor coding according to one implementation of the present disclosure. As shown in FIG. 2A, the encoder/decoder system 200 can include an encoder 225 and a decoder 270. The encoder 225 can include a compression module 230 and a file build module 235. The decoder 270 can include a file deconstruct module 275 and a decompression module 280. The encoder 225 can be configured to generate an output stream 210 based on data 205 (e.g., video, images, audio, constructs, and the like). The decoder 270 can be configured to generate data 215 based on the output stream 210. Data 215 can be reconstructed data corresponding to (representing, associated with, and the like) data 205.

The compression module 230 can be configured to compress data using a plurality of prediction schemes configured to predict a next value (i.e., the next data point) in the data 205. For example, compression module 230 can include a memory configured to store a plurality of prediction schemes that are each configured to predict a value based on the data 205.

In operation, the compression module 230 performs a series of sub-processes for each data point. First, it fetches the current data point and identifies its corresponding prediction neighborhood from previously processed data stored in a buffer (e.g., in the at least one memory 226 of FIG. 2B). The compression module 230 then accesses the plurality of prediction schemes, which may be stored as executable instructions in memory. For a given data point, a subset of these schemes may be selected as candidate predictors based on the topology of the prediction neighborhood. The compression module 230 executes these candidate prediction schemes, which may be performed in parallel to improve throughput, to generate a set of predicted values. These values are then passed to a comparison logic unit, which applies the deterministic rules established by the controller 220 (FIG. 2B). Based on the outcome of this comparison, the controller 220 (FIG. 2B) performs a selection of one of the predicted values to be used for generating the residual value, and signals to the file build module 235 (FIGS. 2A-2B) whether an explicit predictor indicator is required based on this selection

Similarly, the decompression module 280 on the decoder 270 side (as shown in FIGS. 2A and 2C) performs the inverse operations. For each data point, it determines the prediction neighborhood from previously reconstructed data. It then executes the same set of candidate prediction schemes that the encoder would have used for that data point, generating a set of predicted values. The decompression module 280 then applies the identical, shared deterministic logic. If the logic indicates that the predictor index was implicitly coded, the decoder selects the predetermined default predictor from the matching set to combine with the decoded residual value. If the logic indicates that the predictor index was explicitly coded, the decoder reads the predictor index from the encoded stream and uses the specified predictor.

In some cases, the data 205 is received by the compression module 230 as a stream of data. The data stream may be sectioned into a plurality of data points. Data points include a chunk of data, which are sized, for example, depending on the type of data, the type of codec and so forth. Data chunk size may be as small as a single bit of data to several bytes, kilobytes, megabytes, and/or larger data chunks. In some implementations, the compression module 230 divides the data 205 into the plurality of data points as data is received (e.g., as the data is received via a stream). In some implementations, the compression module 230 divides the data 205 into the plurality of data points in larger sections (e.g., after N number of bytes of data is received, the compression module 230 divides the data into a plurality of data points). In some cases, the plurality of data points are part of a 3D mesh, such as the mesh 110 shown in FIG. 1, where each data point corresponds to a vertex (e.g., target vertex 112).

For each data point, the compression module 230 generates, using a prediction scheme, a residual value to add to the output stream. As a simple example, all candidate prediction schemes may predict the same value. A technical benefit of this approach is that, in this example case, the choice of predictor is irrelevant, and the compression module 230 is configured to encode the residual value without including a predictor indicator in the output stream. The decoder 270 (i.e., the decompression module 280) follows the same logic that when all values predicted by the plurality of prediction schemes are the same, the residual is decoded from the encoded stream while the predictor index is not decoded from the encoded stream. To reconstruct the original value (data 205), the residual is added to the value predicted by any of the prediction schemes, which are all the same.

In an example use case, where the data 205 is a 3D mesh, the encoder 225 (via the compression module 230) may be configured to process the mesh vertices (i.e., the data points) sequentially one by one and encodes the positions and other attributes in a sequence. In some cases, when encoding a new vertex position, the value is predicted based on a number of previously encoded vertex positions (i.e., the prediction neighborhood, such as the previously encoded vertices in the prediction neighborhood 114 shown in FIG. 1). The prediction neighborhood includes, for example, nearby vertices (e.g., vertices in the same face and vertices in adjacent faces). In some cases, the prediction neighborhood only includes vertices that have already been encoded.

This method is applicable not only to the geometric position of vertices but also to other vertex attributes that are predictively encoded, such as texture coordinates (UVs) and normals. Each attribute stream can have its own set of specialized prediction schemes, and the implicit coding method can be applied independently to each stream. The application of implicit predictor choice coding has demonstrated measurable reductions in data size for compression efficiency. On the Alliance for Open Media (AOM) Volumetric Visual Media (VVM) dataset for triangular 3D meshes with low quantization of geometry and attribute values, this technique resulted in position, texture coordinate, and normal size reductions of up to 8.6%, 18.2%, and 5.7%, respectively. On average, the size reductions were 1.1% for position, 3.8% for texture coordinates, and 1.2% for normals. These quantitative results show a tangible technical benefit by reducing the final output stream size for the same reconstructed data. For example, while the 3D mesh use case is described in detail, the principles described herein can also be applied to other areas of data compression, such as video codecs (for encoding intra-prediction modes or motion vectors) and image or audio compression where multiple predictive models are employed.

In some implementations, the encoder 225 determines the sequence of visited vertices based on criteria such as maximizing the number of nearby vertices that were already encoded and maintaining the encoded region of vertices to be as convex as possible. Such criteria gives the encoder 225 the possibility of applying a broader range of prediction schemes. In some cases, for each vertex, the set of available predictors may differ based on the properties of the prediction neighborhood, such as the number of vertices in the prediction neighborhood, the types of faces in the neighborhood (triangular vs quadrilateral), vertex connectivity via edges, vertex positions, and the like. For example, one vertex may have two candidate predictors but another vertex have four candidate predictors according to selection criteria used to determine, based on the prediction neighborhood, which of the predictors are candidate predictors for a particular vertex.

The disclosed methods can be applied to a wide variety of prediction schemes. One example of a sophisticated prediction scheme used in 3D mesh compression is the "constrained multi-parallelogram prediction," which is utilized in Google's Draco compression library. In this scheme, the position of a target vertex is predicted by completing a parallelogram formed together with three previously encoded vertices in its prediction neighborhood. To improve accuracy, multiple such parallelograms can be identified, and the final predicted value can be an average of the positions predicted by each parallelogram. The "choice" of the specific combination of parallelograms to use is what would traditionally be encoded in the predictor index. The present method can be applied to such a scheme by, for example, comparing the predicted values generated by different combinations of parallelograms and omitting the index if two or more combinations yield an equivalent result.

The "prediction neighborhood" defines the local context for prediction. In the case of a 3D mesh, the prediction neighborhood for a target vertex is not merely a collection of spatially proximate vertices, but is topologically defined by the mesh connectivity. It is typically composed of vertices that have already been encoded and typically includes the vertices that form faces adjacent to the target vertex. The specific topology of this neighborhood—for instance, the number of available vertices and their arrangement—can influence which prediction schemes are viable. For example, a parallelogram predictor requires at least three previously encoded vertices. Consequently, the set of candidate predictors available to the compression module 230 can be dynamic, changing for each data point based on the properties of its unique prediction neighborhood. The encoder 225 selects a subset of candidate predictors from all available schemes based on this local context before generating the predicted values for comparison.

In many cases, however, the requirement that all of the values provided by each of the plurality of candidate prediction schemes be the same can be difficult to satisfy in some scenarios. Accordingly, the compression module 230 and the decompression module 280 may be configured to use at least one criterion to determine when to include the predictor index. Examples of such criteria can include, but are not limited to: requiring that at least a certain number of predicted values match (e.g., at least two); using a specific mapping of prediction schemes, such that a match between a first pair of schemes results in a default selection, while a match between a different pair does not; or applying different thresholds for different pairs of prediction schemes. The specifics of the at least one criterion can be determined based at least in part on the properties of the prediction schemes and the type of data that is being encoded or decoded.

A technical advantage of this approach is its effectiveness for data with low quantization, where minor, insignificant variations in predicted values are common. The effectiveness arises because for low quantization data, residual values are typically smaller and require fewer bits to encode. As a result, the fixed data savings from omitting a predictor index constitute a more significant portion of the total data required for that data point, making the method particularly impactful in such scenarios. The criteria for determining equivalence can be more flexible than requiring identical values. In some implementations, the controller 220 is configured with a "threshold value," and two predicted values are considered equivalent if the difference between them is within this threshold. The threshold can be a fixed value or can be adapted dynamically based on the characteristics of the data being compressed.

Furthermore, the set of rules can be more complex and hierarchical. For instance, the criteria could specify a sequence of comparisons. A rule could state: "first, compare the values from predictors [0] and [1]. If they are equivalent, use predictor [0] and omit the index. If they are not equivalent, then compare the values from predictors [2] and [3]. If those are equivalent, use predictor [2] and omit the index. Otherwise, select the best predictor from all four and encode the index explicitly." A technical advantage of this hierarchical logic is that it provides more opportunities to find equivalences and omit the predictor index, which can further reduce the size of the output stream. The specific rules are chosen to balance the computational cost of the comparisons with the expected savings in bit rate.

In an example implementation, an encoder 225 and a decoder 270 may be configured to use four candidate prediction schemes, indexed [0], [1], [2], and [3]. In this example, the system is configured to apply implicit coding (i.e., not including the predictor indicator) when at least one of a plurality of predetermined conditions is satisfied. For instance, such conditions may include: a first condition where the values from predictors [0] and [1] are the same; a second condition where the values from predictors [0] and [2] are the same; and a third condition where the values from predictors [1], [2], and [3] are the same.

The application of these criteria can be described in a few scenarios. In a first scenario, if the four predictors generate distinct values (e.g., 42, 37, 33, and 25), none of the conditions for implicit coding are met. Therefore, the encoder selects the best predictor based on other metrics (e.g., the one that produces the smallest residual, in this case, predictor [0]) and explicitly encodes "[0]" as the predictor indicator in the output stream. In a second scenario, if predictors [0] and [1] both generate the value 42, the first condition ([0]=[1]) is met. The shared logic dictates that in this event, a default predictor (e.g., the one with the lower index, [0]) is used. Because the decoder can independently replicate this logic, the predictor indicator is omitted from the output stream. The same implicit coding process occurs if predictors [0] and [2] match, or if predictors [1], [2], and [3] match, as each scenario satisfies one of the predetermined conditions.

The file build module 235 can be configured to generate a file based on a plurality of entropy encoded values representing compressed data 205 and the prediction schemes used to compress the data 205. To facilitate the use of implicit coding, the file build module 235 may structure the output stream to include specific metadata. For instance, the generated file may include a header that contains a flag or identifier indicating that the implicit predictor coding scheme is being used. Such a flag signals to a compliant decoder, such as decoder 270, that it must apply the corresponding deterministic logic during decompression. In more advanced implementations, the header could also include information that specifies the particular set of rules or criteria being used, allowing for the rules to be configured dynamically rather than being fixed. The file deconstruct module 275 on the decoder side is configured to parse this header, identify the use of implicit coding, and configure the decompression module 280 and controller 260 accordingly before processing the stream of residual values.

On the decoder side, the file deconstruct module 275 is configured to process the incoming encoded stream, beginning with the header. The file deconstruct module 275 parses the header to extract metadata, such as a flag indicating that implicit predictor coding is in use, and to identify the specific prediction schemes and deterministic rules employed during encoding. After parsing this information, the file deconstruct module 275 configures the decompression module 280 and controller 260 with the identified compression parameters and passes the entropy-encoded values from the encoded stream to the decompression module 280 for reconstruction.

FIG. 2B illustrates an encoder system 202 according to at least one example implementation. In the example of FIG. 2B, the encoder system 202 may be at least one computing device and should be understood to represent virtually any computing device configured to perform the methods described herein. As such, the encoder system 202 may be understood to include various standard components which may be utilized to implement the techniques described herein, or different or future versions thereof. By way of example, the encoder system is illustrated as including at least one processor 224, as well as at least one memory 226 (e.g., a non-transitory computer-readable storage medium).

Thus, as may be appreciated, the processor 224 may be utilized to execute instructions stored on the memory 226, so as to thereby implement the various features and functions described herein, or additional or alternative features and functions. Of course, the processor 224 and the memory 226 may be utilized for various other purposes. In particular, the memory 226 may be understood to represent an example of various types of memory and related hardware and software which might be used to implement any one of the modules described herein.

As shown in FIG. 2B, the encoder system 202 includes the processor 224, the memory 226, a controller 220, and an encoder 225. The processor 224, the memory 226, the controller 220, and the encoder 225 are communicatively coupled via bus 222.

The processor 224 may be configured to execute computer instructions associated with the controller 220 and/or the encoder 225. The processor 224 may be a shared resource. For example, the encoder 225 may be an element of a larger system (e.g., a 2D or 3D scanner). Therefore, the processor 224 may be configured to execute computer instructions associated with other elements (e.g., controller laser scanner position or movement) within the larger system.

The memory 226 may be configured to store data and/or information associated with the encoder 225. For example, the memory 226 may be configured to store buffers including, for example, buffers storing geometric data, portions of the geometric data, vertex positions, normals, texture coordinates, and other attributes in the geometric data; a number of data points associated with a portion of the geometric data; pixel values such as colors and the alpha channel, and the like. For example, the memory 226 may be configured to store buffers including data associated with, for example, video, audio, images, constructs, and the like.

The controller 220 may be configured to generate various control signals and communicate the control signals to various blocks in the encoder system 202 to predict a next value in a data block (e.g., while encoding the data 205), and to control the omission of a predictor index consistent with the logic illustrated in FIG. 1. In some implementations, the controller 220 acts as the primary logic unit that configures and enforces the shared, deterministic rules for implicit predictor coding. The configuration of the controller can include defining which specific candidate predictors to compare, the threshold values for determining equivalence, and the hierarchy of rules to be applied. The controller 220 communicates these criteria to the compression module 230. After the compression module 230 compares the predicted values for a data point, it is the controller 220 that makes the final determination and signals the file build module 235 to either include an explicit predictor indicator in the output stream or to omit it. The controller 260 in the decoder system 204 is configured with the identical set of rules, ensuring synchronized operation.

FIG. 2C illustrates a decoder system 204 according to at least one example implementation. In the example of FIG. 2C, the decoder system 204 may be at least one computing device and should be understood to represent virtually any computing device configured to perform the methods described herein. As such, the decoder system 204 may be understood to include various standard components which may be utilized to implement the techniques described herein, or different or future versions thereof. By way of example, the decoder 270 is illustrated as including at least one processor 264, as well as at least one memory 266 (e.g., a non-transitory computer-readable storage medium).

As shown in FIG. 2C, the decoder system includes the processor 264, the memory 266, a controller 260, and a decoder 270. The processor 264, the memory 266, the controller 260, and the decoder 270 are communicatively coupled via bus 262.

The processor 264 may be utilized to execute instructions stored on the memory 266, so as to thereby implement the various features and functions described herein, or additional or alternative features and functions. Of course, the processor 264 and the memory 266 may be utilized for various other purposes. In particular, the memory 266 may be understood to represent an example of various types of memory and related hardware and software which might be used to implement any one of the modules described herein. According to example implementations, the encoder system 202 of FIG. 2B and the decoder system 204 FIG. 2C may be included in a same larger system. Further, the processor 264 and the processor 224 may be a single processor, and the memory 266 and the memory 226 may be a single memory. Still further, the controller 260 and the controller 220 may be a same controller.

The processor 264 may be configured to execute computer instructions associated with the controller 260 and/or the decoder 270. The processor 264 may be a shared resource. For example, the decoder system may be an element of a larger system (e.g., a mobile device). Therefore, the processor 264 may be configured to execute computer instructions associated with other elements (e.g., web browsing or wireless communication) within the larger system.

The memory 266 may be configured to store data and/or information associated with the decoder system. For example, the memory 266 may be configured to store buffers including, for example, buffers storing geometric data, portions of the geometric data, vertex positions, normals, texture coordinates, and other attributes in the geometric data; a number of data points associated with a portion of the geometric data; pixel values such as colors and the alpha channel. For example, the memory 266 may be configured to store buffers including, for example, data associated with a video, audio, image, construct, and the like.

The controller 260 may be configured to generate various control signals and communicate the control signals to various blocks in the decoder system 204 to predict a next value from the data stream, including determining when a predictor index has been implicitly omitted from a received encoded stream by applying the deterministic logic shown conceptually in FIG. 1.

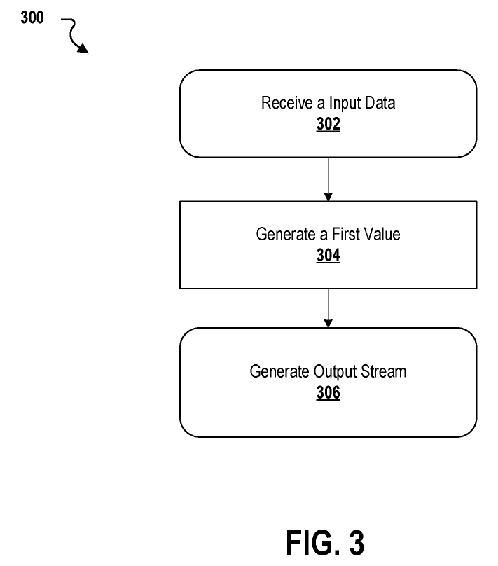

FIG. 3 depicts a flowchart of an example process 300 that can be implemented by implementations of the present disclosure. The example process 300 can be implemented by systems and components described with reference to FIGS. 2A-2C. The example process 300 generally shows in more detail a method for encoding an output stream that selectively includes a predictor indicator based at least in part on a criterion and a threshold value.

For clarity of presentation, the description that follows generally describes the example process 300 in the context of FIGS. 2A-2C. However, it will be understood that the process 300 may be performed, for example, by any other suitable system, environment, software, and hardware, or a combination of systems, environments, software, and hardware as appropriate. In some implementations, various operations of the process 300 can be run in parallel, in combination, in loops, or in any order.

At 302, the encoder 225 receives input data (e.g., data 205) that includes a data point (e.g., the target vertex 112 of the 3D mesh 110 shown in FIG. 1). From 302, the process proceeds to 304 where the encoder 225 generates, via a first candidate prediction scheme, a first value based on a current state. In some implementations, the current state is determined based on information previously read from the input data. In some implementations, the information previously read from the input data (i.e., the prediction neighborhood) includes at least one data point previously read from the input data and encoded to the output stream.

From 304, the process 300 proceeds to 306 where the encoder 225 generates an output stream by adding a residual value (representing a difference between the first value and the data point) and by selectively including a predictor indicator. The determination of whether to include the predictor indicator is based on a comparison between the first value and a second value from a second candidate prediction scheme against a threshold value. Omitting the predictor indicator when the comparison meets the threshold value provides a technical advantage by creating a more compact output stream. The output stream may be, for example, an output stream. In some implementations, the first candidate prediction scheme and the second candidate prediction scheme generate their respective values based on the data point and the current state associated with the input data (e.g., based on previously processed data points, such as data points in a 3D mesh).

For example, when a comparison of the first value and the second value does not meet the threshold value, one of the first or second candidate prediction schemes is selected by determining which scheme generates a value resulting in a residual value having a smaller magnitude. The predictor indicator includes information indicating that the first candidate prediction scheme was used to determine the residual value (i.e., the difference between the first value and the data point) that was added to the output stream. The predictor indicator may be at least one bit whose values map to the possible candidate prediction schemes that may be employed to determine a residual value for a data point. For example, the predictor indicator includes information indicating that the first candidate prediction scheme was used to generate the residual value encoded onto the output stream.

Alternatively, when a comparison of the first value and the second value meets the threshold value, the encoder does not include the predictor indicator as the decoder 270 will generate similar results based on the output stream and encoded residual value for the data point and may use either the first candidate prediction scheme or the second candidate prediction scheme to determine the data point.

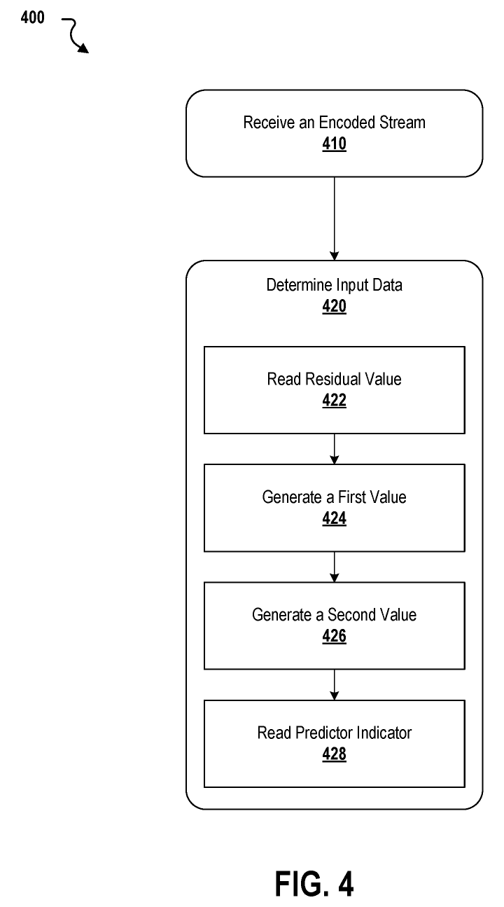

FIG. 4 depicts a flowchart of an example process 400 that can be implemented by implementations of the present disclosure. The example process 400 can be implemented by systems and components described with reference to FIGS. 2A-2C. The example process 400 generally shows in more detail a method for decoding an encoded stream to reconstruct a data point.

For clarity of presentation, a description of the example process 400 is provided below in the context of the systems and components described with reference to FIGS. 2A-2C. However, it will be understood that the process 400 may be performed, for example, by any other suitable system, environment, software, and hardware, or a combination of systems, environments, software, and hardware as appropriate. In some implementations, various operations of the process 400 can be run in parallel, in combination, in loops, or in any order.

At 410, the decoder 270 receives an encoded stream for an input data (e.g., data 205) that includes a data point. The encoded stream includes a residual value for the data point.

From 410, the process 400 proceeds to 420 where the decoder 270 processes the encoded stream to determine the input data (e.g., data 215) by reading (step 422) the residual value from the encoded stream; generating (step 424), via a first candidate prediction scheme, a first value based on a current state, the current state determined based on information previously read from the encoded stream; generating (step 426), via a second candidate prediction scheme, a second value based on the current state; and reading (step 428) a predictor indicator from the encoded stream based on the first value, the second value, and a threshold value, which includes determining that the indicator has been implicitly omitted when the first and second values are equivalent, consistent with the logic shown conceptually (e.g., as shown conceptually in FIG. 1).

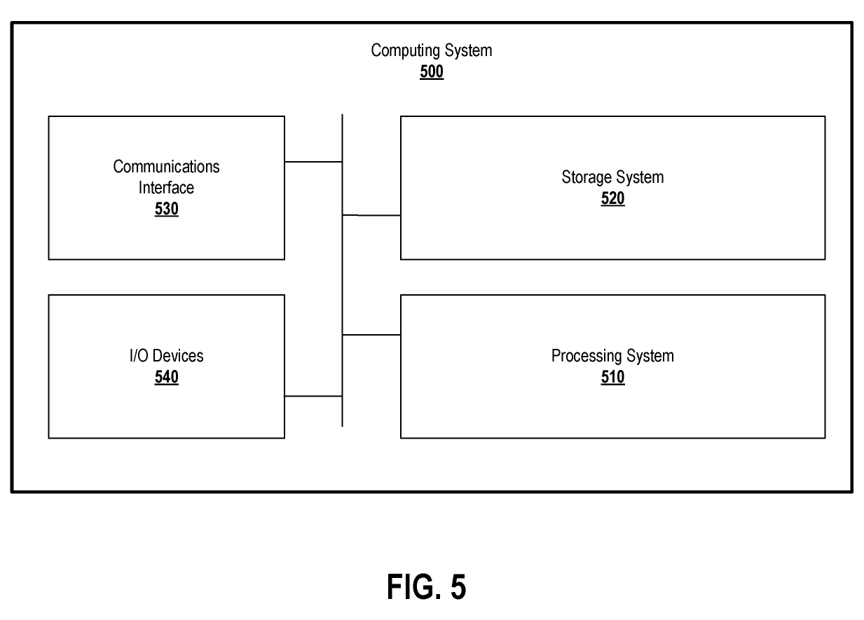

FIG. 5 is a block diagram illustrating an example computing system 500 that can be used to implement the operational architectures, processes, and scenarios disclosed herein. In some examples, the computing system 500 represents the hardware components of the encoder system 202 described in FIG. 2B or the decoder system 204 described in FIG. 2C. The computing system 500 is configured to perform the data compression and decompression tasks described in the preceding figures.

As depicted in FIG. 5, the computing system 500 includes a processing system 510, a storage system 520, a communication interface 530, and one or more I/O devices 540. The processing system 510 is operatively linked to the communication interface 530, the one or more I/O devices 540, and the storage system 520. The computing system 500 can further include other components, such as a power source and an enclosure, that are not shown for clarity. For mobile implementations, the power source is typically a battery.

The processing system 510 includes circuitry that retrieves and executes operating software from the storage system 520. The processing system 510 may be a System-on-Chip (SoC), which integrates multiple processing components onto a single die for power efficiency. Such components can include one or more central processing units (CPUs) that function as general-purpose processor cores for the operating system and application logic, and a graphics processing unit (GPU) or digital signal processor (DSP) for performing parallelized computations, such as those used in advanced prediction schemes.

The one or more Input/Output (I/O) devices 540 can include peripherals that facilitate interaction between a user and the computing system 500 or that allow the system to receive input from the environment. For example, I/O devices 540 may include a network interface for receiving a data stream to be compressed or an encoded stream to be decoded, or a display for rendering reconstructed data, such as a 3D mesh.

The storage system 520 can include volatile and nonvolatile, removable, and non-removable media implemented in any method or technology for storage of information, such as computer-readable instructions, data structures, program modules, or other data. Examples of storage media include random access memory (RAM), read-only memory (ROM), magnetic disks, optical disks, and flash memory. In some implementations, the storage media can be non-transitory.

The processing system 510, which includes at least one processor, is typically mounted on a circuit board that also holds the storage system 520, which functions as at least one memory and a non-transitory computer-readable medium. The memory is communicably coupled to the processor. The memory stores instructions in the form of operating software, which includes computer programs, firmware, or some other form of machine-readable program instructions. When executed by the processor, these instructions cause the system to perform the methods described herein, including the encoding process 300 and the decoding process 400. The execution of these instructions physically configures the general-purpose circuitry of the processor, transforming it into a special-purpose machine specifically designed to solve the identified technical problem of reducing data overhead in output streams.

The execution of these instructions is a concrete, physical process that transforms the computing system 500. For example, to perform the encoding process 300, the processing system 510 fetches a sequence of instructions from the storage system 520. A control unit within the processor decodes these instructions, which in turn physically configure and direct an arithmetic logic unit (ALU) or a DSP to perform specific operations. One set of instructions directs the processor to fetch a data point and its prediction neighborhood from specific memory addresses. The processor then executes multiple candidate prediction schemes to generate a first predicted value and a second predicted value. Another instruction directs the processor to perform a comparison between these values. Based on the result, a conditional instruction directs the processor to either add a predictor indicator to an output stream or to skip that step entirely. The described sequence of physical hardware operations, dictated by the stored software, transforms the general-purpose processing system 510 into a special-purpose machine that generates a technically altered, more efficient output stream, which is a direct technical advantage over conventional methods.

In some implementations, the specific sequence of operations described constitutes an inventive concept that provides a tangible, technical result and amounts to more than an abstract idea. The output of this process—an output stream that is verifiably smaller for the same reconstructed data—is a technically altered data structure. By generating this specific, technically altered data through a non-routine conditional logic, the system provides a direct improvement to the functioning of the computer itself. Specifically, it reduces the computer's storage requirements and lowers the bandwidth needed for data transmission, which are fundamental challenges in computer science. The resulting improvement is not a generic application of a mathematical formula but is a specific technological solution that alters the way the computer represents and handles data, resulting in reduced storage and bandwidth requirements.

The operating software includes instructions that direct the processing system 510 to perform the steps of the disclosed methods, such as the encoding process 300 described with reference to FIG. 3 and the decoding process 400 described with reference to FIG. 4. In some implementations, the computationally intensive tasks of running multiple prediction schemes may be offloaded to a GPU or DSP for parallel processing to improve performance, while the CPU manages the main application logic and output stream construction.

In some implementations, the computing system 500 is configured to perform both the encoding and decoding methods for internal processes. For example, in a local storage and playback workflow, the computing system 500 may encode a data stream (e.g., from a camera sensor), store the resulting output stream in the storage system 520, and subsequently retrieve and decode that same output stream for rendering on a display. In a transcoding or proxy workflow, the system may encode a source media file into an output stream that serves as a proxy version with a different data representation, which is then decoded for real-time processing. Furthermore, in a testing or quality assurance context, the system may perform a loopback test by encoding a data point, immediately decoding the resulting output stream, determining a difference by comparing the reconstructed data point to the data point as it existed prior to the generating the output stream (i.e., the original data point), and generating a quality metric based on that difference.

The systems and methods described herein can be implemented in various ways. In a primarily software-based implementation, the logic of the compression and decompression modules, including the execution of prediction schemes and the application of deterministic rules, can be performed by a general-purpose CPU within the processing system 510. A software-based implementation can provide for a flexible implementation. Alternatively, for certain high-throughput applications, the core logic can be implemented in hardware. For example, the comparison logic and even the execution of certain common prediction schemes could be built into a dedicated Application-Specific Integrated Circuit (ASIC) or configured in a Field-Programmable Gate Array (FPGA). A technical advantage of a hardware implementation is the ability to achieve a higher processing speed by, for example, executing the comparison of multiple predicted values in a single clock cycle.

The configuration of the deterministic rules also allows for different implementations. In one implementation, the set of rules is fixed and standardized. A fixed and standardized set of rules is particularly suitable for implementations intended to become part of an open standard, such as the AOM VVM standard, which facilitates interoperability by allowing compliant decoders to interpret the output stream identically. In another implementation, the rules could be dynamic. For example, an encoder could analyze a piece of content and determine an effective set of rules for that specific data. These rules could then be signaled in the header of the output stream, as generated by the file build module 235. A decoder would first read this header to configure its controller 260 with the appropriate rules before beginning decompression. A technical advantage of this dynamic approach is the potential for high compression efficiency by tailoring the rules to the specific data being compressed.

Furthermore, while the examples provided often refer to a specific number of candidate predictors (e.g., four), the underlying principle can be applied to various scenarios involving two or more candidate prediction schemes. The logic can be scaled to accommodate any number of predictors, and the criteria can be defined for any subset of those predictors, which provides for flexible and broad applicability to predictive codecs.

It is also to be understood that although certain drawings illustrate hardware and software located within particular devices, these depictions are for illustrative purposes only. In some implementations, the illustrated components may be combined or divided into separate software, firmware, or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links.

Moreover, various implementations of the systems and techniques described herein can be realized in digital electronic circuitry, integrated circuitry, specially designed hardware such as application-specific integrated circuits, computer hardware, firmware, software, or combinations thereof. These various implementations can include implementation in one or more computer programs that are executable or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications, or code) include computer readable or machine instructions for a programmable electronic processor and can be implemented in a high-level procedural or object-oriented programming language, or in assembly/machine language. As used herein, the terms “machine-readable medium” and “computer-readable medium” refer to any computer program product, apparatus or device (e.g., magnetic discs, optical disks, memory, Programmable Logic Devices (PLDs)) used to provide machine instructions or data to a programmable processor, including a machine-readable medium that receives machine instructions as a machine-readable signal. The term “machine-readable signal” refers to any signal used to provide machine instructions or data to a programmable processor.

The functionality of the computer readable instructions may be combined or distributed as desired in various environments. In some implementations, a computer program includes one sequence of instructions. In some implementations, a computer program includes a plurality of sequences of instructions. In some implementations, a computer program is provided from one location. In other implementations, a computer program is provided from a plurality of locations. In various implementations, a computer program includes one or more software modules. In various implementations, a computer program includes, in part or in whole, one or more web applications, one or more mobile applications, one or more standalone applications, one or more web browser plug-ins, extensions, add-ins, or add-ons, or combinations thereof.

Unless otherwise defined, the technical terms used herein have the same meaning as commonly understood by one of ordinary skill in the art to which the present subject matter belongs. As used in this specification and the appended claims, the singular forms “a,” “an,” and “the” include plural references unless the context clearly dictates otherwise. Any reference to “or” herein is intended to encompass “and/or” unless otherwise stated.

A number of implementations have been described. It will be understood that various modifications, including the separation or integration of system components, may be made without departing from the spirit and scope of the disclosure. It should be understood that various alternatives to the implementations described may be employed, and the appended claims are intended to cover such variations and changes as fall within the spirit of the described subject matter.

Clause 1. A method comprising: receiving input data that includes a data point; generating, via a first candidate prediction scheme, a first value based at least in part on a current state, the current state determined based at least in part on information previously read from the input data; generating, via a second candidate prediction scheme, a second value based at least in part on the current state; and generating an output stream that includes a residual value, wherein the residual value is a difference between the data point and one of the first value or the second value.

Clause 2. The method of clause 1, further comprising selecting one of the first value or the second value based at least in part on a comparison of the first value and the second value against a threshold value, wherein the residual value is based at least in part on the selected one of the first value or the second value.

Clause 3. The method of clause 2, further comprising including a predictor indicator in the output stream when the comparison indicates a difference between the first value and the second value is outside the threshold value.

Clause 4. The method of clause 3, wherein one of the first candidate prediction scheme or the second candidate prediction scheme is selected by determining which scheme generates a value resulting in a residual value having a smaller magnitude, and the predictor indicator identifies the selected scheme.

Clause 5. The method of clause 2, further comprising omitting a predictor indicator from the output stream when the comparison indicates a difference between the first value and the second value is within the threshold value.

Clause 6. The method of clause 5, wherein the residual value is based at least in part on a predetermined one of the first candidate prediction scheme or the second candidate prediction scheme.

Clause 7. The method of clause 2, further comprising generating at least a third value via a third candidate prediction scheme, wherein the one of the first value or the second value is selected further based at least in part on a comparison of the third value.

Clause 8. The method of clause 7, wherein the one of the first value or the second value is selected by: performing a first comparison between the first value and the second value; and performing a second comparison between a different pair of values from among the first value, the second value, and the third value when the first comparison indicates a difference between the first value and the second value is outside the threshold value.

Clause 9. The method of clause 2, wherein the threshold value is dynamically adapted based at least in part on one or more characteristics of the current state.

Clause 10. The method of clause 1, wherein the input data is a three-dimensional mesh, and the data point is a target vertex of the three-dimensional mesh, and the current state includes a prediction neighborhood of previously encoded vertices that are topologically connected to the target vertex.

Clause 11. The method of clause 10, wherein the target vertex includes a vertex attribute selected from a group consisting of a vertex position, a vertex normal, and a texture coordinate.

Clause 12. The method of clause 10, wherein at least one of the first candidate prediction scheme or the second candidate prediction scheme is a parallelogram-based prediction scheme that generates a predicted value for the target vertex by completing a parallelogram formed by three vertices from the prediction neighborhood.

Clause 13. The method of clause 1, wherein generating the output stream further includes including a flag in a header of the output stream, the flag indicating that a predictor indicator may be omitted from the output stream.

Clause 14. A method comprising: receiving an encoded stream that includes a residual value for a data point; and reconstructing the data point from the encoded stream by: generating, via a first candidate prediction scheme, a first value based at least in part on a current state, the current state determined based at least in part on information previously read from the encoded stream; generating, via a second candidate prediction scheme, a second value based at least in part on the current state; and reconstructing the data point using the residual value and one of the first value or the second value.

Clause 15. The method of clause 14, further comprising selecting the one of the first value or the second value based at least in part on a comparison of the first value and the second value against a threshold value.

Clause 16. The method of clause 15, wherein the one of the first value or the second value is selected by reading a predictor indicator from the encoded stream when the comparison indicates a difference between the first value and the second value is outside the threshold value.

Clause 17. The method of clause 15, wherein a predetermined one of the first value or the second value is selected when the comparison indicates a difference between the first value and the second value is within the threshold value.

Clause 18. The method of clause 15, further comprising generating at least a third value via a third candidate prediction scheme, wherein the one of the first value or the second value is selected further based at least in part on a comparison of the third value.

Clause 19. The method of clause 18, wherein the one of the first value or the second value is selected by: performing a first comparison between the first value and the second value; and performing a second comparison between a different pair of values from among the first value, the second value, and the third value when the first comparison indicates a difference between the first value and the second value is outside the threshold value.

Clause 20. The method of clause 15, wherein the threshold value is dynamically adapted based at least in part on one or more characteristics of the current state.

Clause 21. The method of clause 14, wherein the encoded stream represents a three-dimensional mesh, the data point is a target vertex of the three-dimensional mesh, and the current state includes a prediction neighborhood of previously reconstructed vertices that are topologically connected to the target vertex.

Clause 22. The method of clause 21, wherein the target vertex includes a vertex attribute selected from a group consisting of a vertex position, a vertex normal, and a texture coordinate.

Clause 23. The method of clause 21, wherein at least one of the first candidate prediction scheme or the second candidate prediction scheme is a parallelogram-based prediction scheme that generates a predicted value for the target vertex by completing a parallelogram formed by three vertices from the prediction neighborhood.

Clause 24. The method of clause 14, wherein receiving the encoded stream further includes reading a flag from a header of the encoded stream, the flag indicating that a predictor indicator may be omitted from the encoded stream.

Clause 25. A system comprising: at least one processor; and at least one memory storing instructions that, when executed by the at least one processor, cause the system to perform a method comprising: generating a first predicted value and a second predicted value for a data point based at least in part on a current state; generating an output stream including a residual value based at least in part on one of the first predicted value or the second predicted value; and reconstructing the data point from the output stream by: generating the first predicted value and the second predicted value for the data point based at least in part on the current state; and reconstructing the data point using the residual value from the output stream and one of the first predicted value or the second predicted value.

Clause 26. The system of clause 25, wherein the method further comprises: storing the output stream in the at least one memory; and subsequently retrieving the output stream from the at least one memory, reconstructing the data point from the output stream, and providing the reconstructed data point for rendering on a display communicatively coupled to the at least one processor.

Clause 27. The system of clause 25, wherein the data point is part of a source media file, and generating the output stream includes creating a proxy version of the source media file, the proxy version having a different data representation than the source media file.

Clause 28. The system of clause 25, wherein the method further comprises: determining a difference between the reconstructed data point and the data point prior to the generating the output stream by comparing the reconstructed data point to the data point; and generating a quality metric based at least in part on the difference.

Clause 29. The system of clause 25, wherein the method further comprises selecting one of the first predicted value or the second predicted value based at least in part on a comparison of the first predicted value and the second predicted value against a threshold value, the selecting including: including, when a difference between the first predicted value and the second predicted value is outside the threshold value, a predictor indicator in the output stream that identifies the selected one of the first or second predicted value that results in the residual value having a smaller magnitude; and omitting, when the difference is within the threshold value, the predictor indicator from the output stream, wherein the residual value is based at least in part on a predetermined one of the first predicted value or the second predicted value.

Clause 30. The system of clause 29, wherein selecting one of the first predicted value or the second predicted value during the reconstructing includes: reading the predictor indicator from the output stream when the difference between the first predicted value and the second predicted value is outside the threshold value; and selecting the predetermined one of the first predicted value or the second predicted value when the difference is within the threshold value.

What is claimed is:

1. A method comprising:
receiving input data that includes a data point;
generating, via a first candidate prediction scheme, a first value based at least in part on a current state, the current state determined based at least in part on information previously read from the input data;
generating, via a second candidate prediction scheme, a second value based at least in part on the current state; and
generating an output stream that includes a residual value, wherein the residual value is a difference between the data point and one of the first value or the second value.

2. The method of claim 1, further comprising selecting one of the first value or the second value based at least in part on a comparison of the first value and the second value against a threshold value, wherein the residual value is based at least in part on the selected one of the first value or the second value.

3. The method of claim 2, further comprising including a predictor indicator in the output stream when the comparison indicates a difference between the first value and the second value is outside the threshold value.

4. The method of claim 3, wherein one of the first candidate prediction scheme or the second candidate prediction scheme is selected by determining which scheme generates a value resulting in a residual value having a smaller magnitude, and the predictor indicator identifies the selected scheme.

5. The method of claim 2, further comprising omitting a predictor indicator from the output stream when the comparison indicates a difference between the first value and the second value is within the threshold value.

6. The method of claim 5, wherein the residual value is based at least in part on a predetermined one of the first candidate prediction scheme or the second candidate prediction scheme.

7. The method of claim 2, further comprising generating at least a third value via a third candidate prediction scheme, wherein the one of the first value or the second value is selected further based at least in part on a comparison of the third value.

8. The method of claim 7, wherein the one of the first value or the second value is selected by:
performing a first comparison between the first value and the second value; and
performing a second comparison between a different pair of values from among the first value, the second value, and the third value when the first comparison indicates a difference between the first value and the second value is outside the threshold value.

9. The method of claim 2, wherein the threshold value is dynamically adapted based at least in part on one or more characteristics of the current state.

10. The method of claim 1, wherein the input data is a three-dimensional mesh and the data point is a target vertex of the three-dimensional mesh, and the current state includes a prediction neighborhood of previously encoded vertices that are topologically connected to the target vertex.

11. The method of claim 10, wherein the target vertex includes a vertex attribute selected from a group consisting of a vertex position, a vertex normal, and a texture coordinate.

12. The method of claim 10, wherein at least one of the first candidate prediction scheme or the second candidate prediction scheme is a parallelogram-based prediction scheme that generates a predicted value for the target vertex by completing a parallelogram formed by three vertices from the prediction neighborhood.

13. The method of claim 1, wherein generating the output stream further includes including a flag in a header of the output stream, the flag indicating that a predictor indicator may be omitted from the output stream.

14. A method comprising:
receiving an encoded stream that includes a residual value for a data point; and
reconstructing the data point from the encoded stream by:
generating, via a first candidate prediction scheme, a first value based at least in part on a current state, the current state determined based at least in part on information previously read from the encoded stream;
generating, via a second candidate prediction scheme, a second value based at least in part on the current state; and
reconstructing the data point using the residual value and one of the first value or the second value.

15. The method of claim 14, further comprising selecting the one of the first value or the second value based at least in part on a comparison of the first value and the second value against a threshold value.

16. The method of claim 15, wherein the one of the first value or the second value is selected by reading a predictor indicator from the encoded stream when the comparison indicates a difference between the first value and the second value is outside the threshold value.

17. The method of claim 15, wherein a predetermined one of the first value or the second value is selected when the comparison indicates a difference between the first value and the second value is within the threshold value.

18. The method of claim 15, further comprising generating at least a third value via a third candidate prediction scheme, wherein the one of the first value or the second value is selected further based at least in part on a comparison of the third value.

19. The method of claim 18, wherein the one of the first value or the second value is selected by:
performing a first comparison between the first value and the second value; and
performing a second comparison between a different pair of values from among the first value, the second value, and the third value when the first comparison indicates a difference between the first value and the second value is outside the threshold value.

20. The method of claim 15, wherein the threshold value is dynamically adapted based at least in part on one or more characteristics of the current state.

21. The method of claim 14, wherein the encoded stream represents a three-dimensional mesh, the data point is a target vertex of the three-dimensional mesh, and the current state includes a prediction neighborhood of previously reconstructed vertices that are topologically connected to the target vertex.

22. The method of claim 21, wherein the target vertex includes a vertex attribute selected from a group consisting of a vertex position, a vertex normal, and a texture coordinate.

23. The method of claim 21, wherein at least one of the first candidate prediction scheme or the second candidate prediction scheme is a parallelogram-based prediction scheme that generates a predicted value for the target vertex by completing a parallelogram formed by three vertices from the prediction neighborhood.

24. The method of claim 14, wherein receiving the encoded stream further includes reading a flag from a header of the encoded stream, the flag indicating that a predictor indicator may be omitted from the encoded stream.

25. A system comprising:
at least one processor; and
at least one memory storing instructions that, when executed by the at least one processor, cause the system to perform a method comprising:
generating a first predicted value and a second predicted value for a data point based at least in part on a current state;
generating an output stream including a residual value based at least in part on one of the first predicted value or the second predicted value; and
reconstructing the data point from the output stream by:
generating the first predicted value and the second predicted value for the data point based at least in part on the current state; and
reconstructing the data point using the residual value from the output stream and one of the first predicted value or the second predicted value.

26. The system of claim 25, wherein the method further comprises:
storing the output stream in the at least one memory; and
subsequently retrieving the output stream from the at least one memory, reconstructing the data point from the output stream, and providing the reconstructed data point for rendering on a display communicatively coupled to the at least one processor.

27. The system of claim 25, wherein the data point is part of a source media file, and generating the output stream includes creating a proxy version of the source media file, the proxy version having a different data representation than the source media file.

28. The system of claim 25, wherein the method further comprises:
determining a difference between the reconstructed data point and the data point prior to the generating the output stream by comparing the reconstructed data point to the data point; and
generating a quality metric based at least in part on the difference.

29. The system of claim 25, wherein the method further comprises selecting one of the first predicted value or the second predicted value based at least in part on a comparison of the first predicted value and the second predicted value against a threshold value, the selecting including:
including, when a difference between the first predicted value and the second predicted value is outside the threshold value, a predictor indicator in the output stream that identifies the selected one of the first or second predicted value that results in the residual value having a smaller magnitude; and
omitting, when the difference is within the threshold value, the predictor indicator from the output stream, wherein the residual value is based at least in part on a predetermined one of the first predicted value or the second predicted value.

30. The system of claim 29, wherein selecting one of the first predicted value or the second predicted value during the reconstructing includes:
reading the predictor indicator from the output stream when the difference between the first predicted value and the second predicted value is outside the threshold value; and
selecting the predetermined one of the first predicted value or the second predicted value when the difference is within the threshold value.
